(19) United States
(12) Patent Application Publication
(10) Pub. No.: US 2015/0120451 A1
(43) Pub. Date: Apr. 30, 2015

(54) METHOD AND APPARATUS FOR ACQUIRING MERCHANT INFORMATION

(71) Applicant: TENCENT TECHNOLOGY (SHENZHEN) COMPANY LIMITED, Shenzhen (CN)

(72) Inventor: DAWEI JIANG, Shenzhen (CN)

(73) Assignee: TENCENT TECHNOLOGY (SHENZHEN) COMPANY LIMITED

(21) Appl. No.: 14/592,037

(22) Filed: Jan. 8, 2015

Related U.S. Application Data
(63) Continuation of application No. PCT/CN2014/079322, filed on Jun. 6, 2014.

(30) Foreign Application Priority Data
Aug. 6, 2013 (CN) 2013-10339901.9

(51) Int. Cl. G06Q 30/02

(52) U.S. Cl. CPC G06Q 30/0257; G06Q 30/0261; G06Q 30/0267
USPC 705/14.55

(57) ABSTRACT

Methods and apparatus for acquiring merchant information are provided herein. An information acquiring instruction triggered by a user is received. The information acquiring instruction is configured to acquire merchant information. Current location information of the user is required according to the information acquiring instruction. The location information and the merchant information to be acquired are sent to a server connected to a network. The server matches information according to the received location information and the merchant information. A collection of the merchant information is returned from the server. The collection of the merchant information includes information of a plurality of merchants. The information of the plurality of merchants is displayed.

### CROSS-REFERENCES TO RELATED APPLICATIONS

This application is a continuation application of PCT Patent Application No. PCT/CN2014/079322, filed on Jun. 6, 2014, which claims priority to Chinese Patent Application No. 201310339901.9, filed on Aug. 6, 2013, the entire contents of which are incorporated herein by reference.

### FIELD OF THE DISCLOSURE

The present disclosure relates to the field of internet technology and, more particularly, relates to methods and apparatus for acquiring merchant information.

### BACKGROUND

In order to provide users with expected and surprising user experience, current third-party applications provide feedback of merchant information by the following methods. A user shakes a mobile phone after the user enters a shaking acquiring interface. The third-party application is triggered by the shaking operation from the user to search for merchant information of a pre-set merchant type surrounding current location. The third-party application then sends the merchant information back to the user. As such, the user may shake the mobile phone to randomly acquire information of one merchant from the surrounding area.

Such process for acquiring merchant information, however, has drawbacks. For example, because the third-party application searches for information of one merchant directly in the area surrounding current location after a triggering instruction is received, information of only one merchant (e.g., a restaurant) can be resulted after each search. When the user needs to search for other merchants, the user has to shake the mobile phone again to generate a triggering instruction for another search. This makes the operation tedious and complicated.

### BRIEF SUMMARY OF THE DISCLOSURE

According to various embodiments, there is provided a method for acquiring merchant information. An information acquiring instruction triggered by a user is received. The information acquiring instruction is configured to acquire merchant information. Current location information o f the user is required according to the information acquiring instruction. The location information and the merchant information to be acquired are sent to a server connected to a network. The server matches information according to the received location information and the merchant information. A collection of the merchant information is returned from the server. The collection of the merchant information includes information of a plurality of merchants. The information of the plurality of merchants is displayed.

According to various embodiments, there is also provided a merchant information acquiring apparatus. The merchant information acquiring apparatus includes a first receiving unit, an acquiring unit, a sending unit, a second receiving unit, and a first displaying unit.

The first receiving unit is configured to receive an information acquiring instruction triggered by a user. The information acquiring instruction is configured to acquire the merchant information. The acquiring unit is configured to acquire current location information of the user according to the information acquiring instruction received by the first receiving unit. The sending unit is configured to send the location information acquired by the acquiring unit and the merchant information to be acquired received by the first receiving unit to a server connected to a network. The server matches information according to the received location information and the merchant information. The second receiving unit is configured to receive a collection of the merchant information returned from the server. The collection of the merchant information includes information of a plurality of merchants. The first displaying unit is configured to display the information of the plurality of merchants received by the second receiving unit.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method of acquiring merchant information consistent with various disclosed embodiments;

FIG. 2 depicts another exemplary method of acquiring merchant information consistent with various disclosed embodiments;

FIG. 3 depicts another exemplary method of acquiring merchant information consistent with various disclosed embodiments;

FIG. 4 depicts an exemplary apparatus of acquiring merchant information consistent with various disclosed embodiments;

FIG. 5 depicts another exemplary apparatus of acquiring merchant information consistent with various disclosed embodiments;

FIG. 6 depicts an exemplary environment incorporating certain disclosed embodiments; and

FIG. 7 depicts an exemplary computer system consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

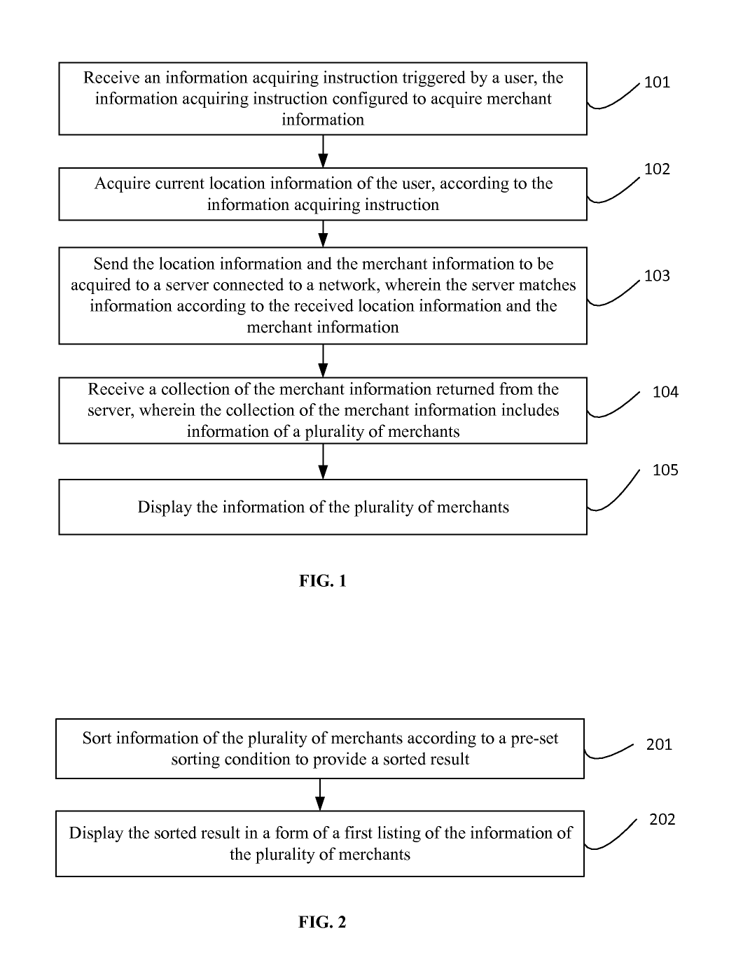

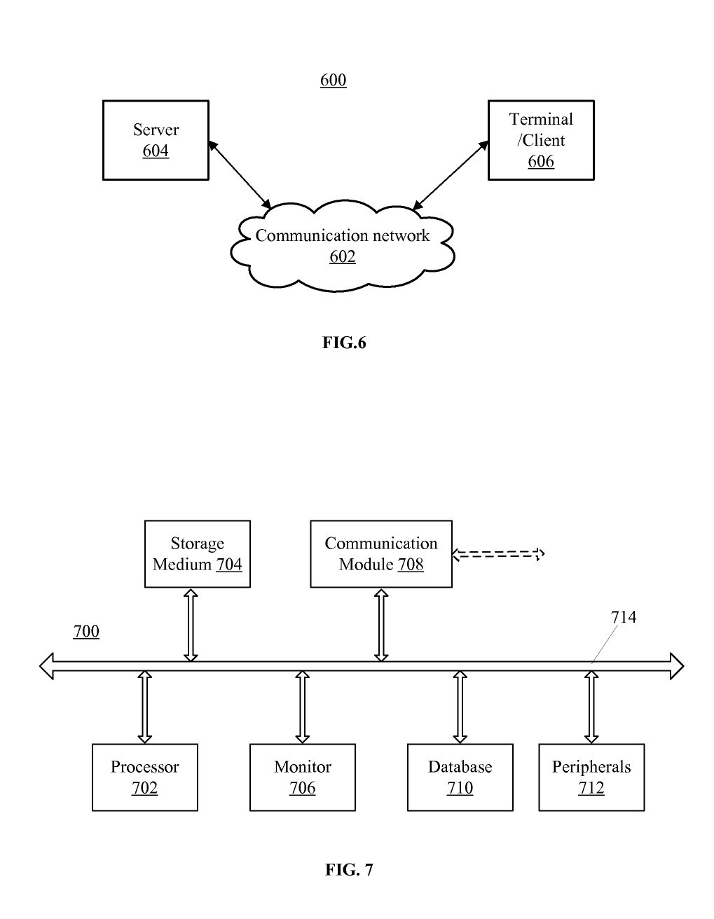

FIGS. 1-5 depict exemplary methods and apparatus for acquiring merchant information in accordance with various disclosed embodiments. The exemplary methods and apparatus can be implemented, for example, in an exemplary environment 600 as shown in FIG. 6.

As shown in FIG. 6, the environment 600 can include a server 604, a terminal 606, and a communication network 602. The server 604 and the terminal 606 may be coupled through the communication network 602 for information exchange, for example, Internet searching, webpage browsing, etc. Although only one terminal 606 and one server 604 are shown in the environment 600, any number of terminals 606 or servers 604 may be included, and other devices may also be included.

The communication network 602 may include any appropriate type of communication network for providing network connections to the server 604 and terminal 606 or among multiple servers 604 or terminals 606. For example, the communication network 602 may include the Internet or other types of computer networks or telecommunication networks, either wired or wireless.

A terminal, as used herein, may refer to any appropriate user terminal device with certain computing capabilities, for example, a personal computer (PC), a work station computer, a notebook computer, a car computer (e.g., carrying in a car or other vehicles), a server computer, a hand-held computing device (e.g., a tablet computer), a mobile terminal (e.g., a mobile phone, a smart phone, an iPad, and/or an aPad), a POS (i.e., point of sale) device, or any other user-side computing device. In various embodiments, the terms “terminal” and “terminal device” can be used interchangeably.

A server, as used herein, may refer one or more server computers configured to provide certain server functionalities, for example, search engines and database management. A server may also include one or more processors to execute computer programs in parallel

The server 604 and the terminal 606 maybe implemented on any appropriate computing platform. FIG. 7 shows a block diagram of an exemplary computing system 700 capable of implementing the server 604 and/or the terminal 606. As shown in FIG. 7, the exemplary computer system 700 may include a processor 702, a storage medium 704, a monitor 706, a communication module 708, a database 710, peripherals 712, and one or more bus 714 to couple the devices together. Certain devices maybe omitted and other devices may be included.

The processor 702 can include any appropriate processor or processors. Further, the processor 702 can include multiple cores for multi-thread or parallel processing. The storage medium 704 may include memory modules, for example, ROM, RAM, and flash memory modules, and mass storages, for example, CD-ROM, U-disk, removable hard disk, etc. The storage medium 704 may store computer programs for implementing various processes, when executed by the processor 702.

Further, the peripherals 712 may include I/O devices, for example, keyboard and mouse, and the communication module 708 may include network devices for establishing connections through the communication network 602. The database 710 may include one or more databases for storing certain data and for performing certain operations on the stored data, for example, webpage browsing, database searching, etc.

In operation, the terminal 606 may cause the server 604 to perform certain actions, for example, an Internet search or other database operations. The server 604 may be configured to provide structures and functions for such actions and operations. More particularly, the server 604 may include a data searching system for real-time database searching. In various embodiments, a terminal, for example, a mobile terminal involved in the disclosed methods and systems can include the terminal 606.

For example, a method of acquiring merchant information is provided. The method can be implemented in any mobile terminals including, for example, smart phones, tablet computers, or any other terminals as discussed above.

FIG. 1 depicts an exemplary method o f acquiring merchant information consistent with various disclosed embodiments. In Step 101, an information acquiring instruction triggered by a user is received. The information acquiring instruction is configured to acquire merchant information.

After the user selects a specific merchant type from a listing of merchant types, the user can trigger the information acquiring instruction by shaking the mobile phone, or by blowing near the microphone of the mobile phone, or by pressing a sending functioned key.

In Step 102, current location information of the user is acquired. The location information can be acquired by a GPS positioning system of the mobile phone or by a network address of the local network where the user is located therein.

In Step 103, location information and the merchant information to be acquired are sent to a server connected to a network. The server may also be referred to as a network-side server. The server matches information according to the received location information and the merchant information.

When the user uses a mobile network, the location information and the merchant information can be sent by the mobile network provided by the mobile network operator. When the user uses a wireless LAN, the location information and the merchant information can be sent to a wireless router for the wireless router to forward the information to the server connected to the network.

In Step 104, a collection of the merchant information is returned from the server. The collection of the merchant information includes information of a plurality of merchants. The merchant information includes data of a merchant name, a merchant address, a distance between the merchant address and the current location of the user, an average spending per person, business hours, an account-linked address, and/or a combination thereof.

In Step 105, the information of the plurality of merchants is displayed. Merchant information can be displayed continuously on one page. Or, information of a pre-set number (e.g., about 5) of merchants can be displayed on one single page. By operations of switching to a different page, multiple pages can be used to display information of merchants.

In the disclosed method of acquiring merchant information, when an information acquiring instruction triggered by a user is received, current location information of the user can be acquired. Specific merchant type selected by the user and the location information of the user can be sent to a server connected to a network. A collection of the merchant information returned from the server can be received, and information of the plurality of merchants can be displayed. While, conventionally, information of only one merchant maybe displayed and the user has to shake the mobile phone for another time to trigger the search for other merchants surrounding the area, the disclosed method can provide information of the plurality of merchants for the user in one single displaying process.

Another exemplary method of acquiring merchant information can be provided. Based on the method depicted in FIG. 1, other steps can be added. For example, prior to performing Step 101 of receiving the information acquiring instruction triggered by the user, the exemplary method further includes displaying a selection interface.

The selection interface is configured for the user to select a merchant type. The selection interface can be an interface for a shaking operation (e.g., to shake a mobile phone back and forth for one or more times) or an interface for a voice controlled operation (e.g., to blow into a microphone of a mobile phone for one or more times). A listing of merchant types can be displayed on the selection interface so as to provide different merchant types for the user for, e.g., dining, shopping, banking, group purchasing, etc.

A selection instruction from the user is then received. The selection instruction contains a selected merchant type selected by the user from the selection interface. When the user selects a specific merchant type from the listing of merchant types, the selection instruction is triggered. The selection instruction contains a specific merchant type itself (e.g., catering or dining), or an identification containing the specific merchant type (e.g., dining ID 01).

In the disclosed method of acquiring merchant information, different merchant types are displayed on the selection (or displaying) interface for the user to select. The user can select a desired merchant type from the selection interface to further expand the scope for searching the merchant information and to ensure the accuracy of the search.

The present disclosure provides another method of acquiring merchant information. As a specific example of the method depicted in FIG. 1, the exemplary Step 105 of displaying the information o f the plurality of merchants can include the following.

The information of the plurality of merchants can be displayed in the form of listing of the information of the plurality of merchants. The received merchant information is displayed in the form of listing, with each listing item corresponding to a datum. If the information of all merchants cannot be displayed by one listing (e.g., on one page), information of a pre-set number of merchants can be displayed in each listing on multiple pages.

In the disclosed method of acquiring merchant information, using a listing to display merchant information can provide users with more intuitive merchant information.

The present disclosure provides another method of acquiring merchant information. As a specific example of the method depicted in FIG. 1, the exemplary Step 103 of receiving the information acquiring instruction triggered by the user for acquiring the merchant information can include the following.

For example, a shaking acquiring instruction triggered by the user can be received. The shaking acquiring instruction can be an instruction triggered by a shaking operation. Or, a voice acquiring instruction triggered by the user can be received. The voice acquiring instruction can be an instruction triggered by a pre-set audio.

The shaking acquiring instruction and the voice acquiring instruction are different examples of the information acquiring instruction having different triggering conditions. When the user shakes a mobile phone, the shaking acquiring instruction is triggered. A change of acceleration of the mobile phone due to the shaking can be acquired by an acceleration sensor. When the change of acceleration reaches a threshold, the acceleration sensor generates the shaking acquiring instruction. Or, when the user blows onto the microphone of the mobile phone or makes a pre-set voice, the voice acquiring instruction is triggered. Or, when the user clicks on the “Search” button/key or other suitable functional buttons/keys, the information acquiring instruction is triggered.

Further, in Step 101, when a selection screen is displayed, a text note consistent with the triggering method is displayed on the displaying interface including, for example, shaking(s), blowing(s), clicking(s), and/or tapping(s). When “shaking(s)” is displayed on the selection interface, the user can trigger the information acquiring instruction by shaking the mobile phone back and forth for one or more times such that the shaking acquiring instruction triggered by the user can be received. Or, when “blowing(s)” is displayed on the selection interface, the user can trigger the information acquiring instruction by blowing into the microphone of the mobile phone such that the voice acquiring instruction triggered the user can be received. Or, when “clicking(s)” is displayed on the selection interface, the user can trigger the information acquiring instruction by clicking on the “Search” button/key or other suitable functional button/key.

Further, before the displaying of the selection interface, the user can be provided with various triggering selection directories. A triggering selection directory can be depicted in Table 1. The triggering selection directory can include various triggering methods to generate information acquiring instructions.

TABLE 1
Triggering Selection Directory
Shaking(s)
Blowing(s)
Clicking(s)

The method of acquiring merchant information provided by the present disclosure can trigger information acquiring instruction when the user shakes the mobile phone or blows into the microphone of the mobile phone. The user experience can be enhanced greatly when the initiation of information acquiring instruction are triggered after using the body movement (e.g., shaking and blowing) of the user.

The present disclosure provides another exemplary method of acquiring merchant information. As a specific example of the method depicted in FIG. 1, the Step 101 of displaying the selection interface includes displaying a listing of the merchant type that contains at least two selection levels.

A listing of the merchant type can include a listing with a primary selection level as depicted in Table 2, or a listing with a primary selection level and a secondary selection level as depicted in Table 3, or a listing with further selection levels. In table 2, the items displayed in the primary selection level menu correspond to various business areas. Table 3-1 is a menu displayed at the primary selection level. Table 3-2 is a menu displayed at secondary selection level. After the user clicks on an item at a certain level of the menu, in a case that there is a secondary selection level menu corresponding to the item at that primary selection level menu clicked by the user, the secondary selection level menu can be displayed for the user to make accurate selection.

Further, if there is a tertiary level menu corresponding to the item at the second level menu selected by the user, the tertiary selection level menu can be displayed for the user to make accurate selection.

TABLE 2
Listing of Merchant Type
Dining
Accommodation
Banking
Group purchasing
Coupon

The method of acquiring merchant information provided by the present disclosure can provide the user with more accurate options for the user to select, by displaying a listing of the merchant type with at least two selection levels. In this manner, the user can find a merchant more accurately with improved accuracy of searching.

TABLE 3
Table 3-I
Listing of Merchant Type
Dining
Accommodation
Banking
Group Purchasing
Coupon
Table 3-II
Xiang style
Ao style
Lu style
Chuan style

The present disclosure provides another exemplary method of acquiring merchant information. In a specific example for the method depicted in FIG. 1, the exemplary Step 105 of displaying the information of the plurality of merchants in the form of listing includes a process as depicted in FIG. 2.

In Step 201, information of the plurality of merchants is sorted according to a pre-set sorting (or filtering) condition to provide a sorted result.

The merchant information includes data of a merchant name, a merchant address, a distance between the merchant address and the current location of the user, an average spending per person, business hours, an account link address, and/or a combination thereof. During the sorting, the pre-sorting condition sorts the information of the plurality of merchants in an ascending order based on a distance from the merchant address to the current location of the user.

In Step 202, the sorted result is displayed in a form of a first listing of the information of the plurality of merchants. The method of acquiring merchant information provided by the present disclosure can thus sort the information of the plurality of merchants according to the pre-set sorting method. This provides convenience for the user to compare and to improve the efficiency of searching.

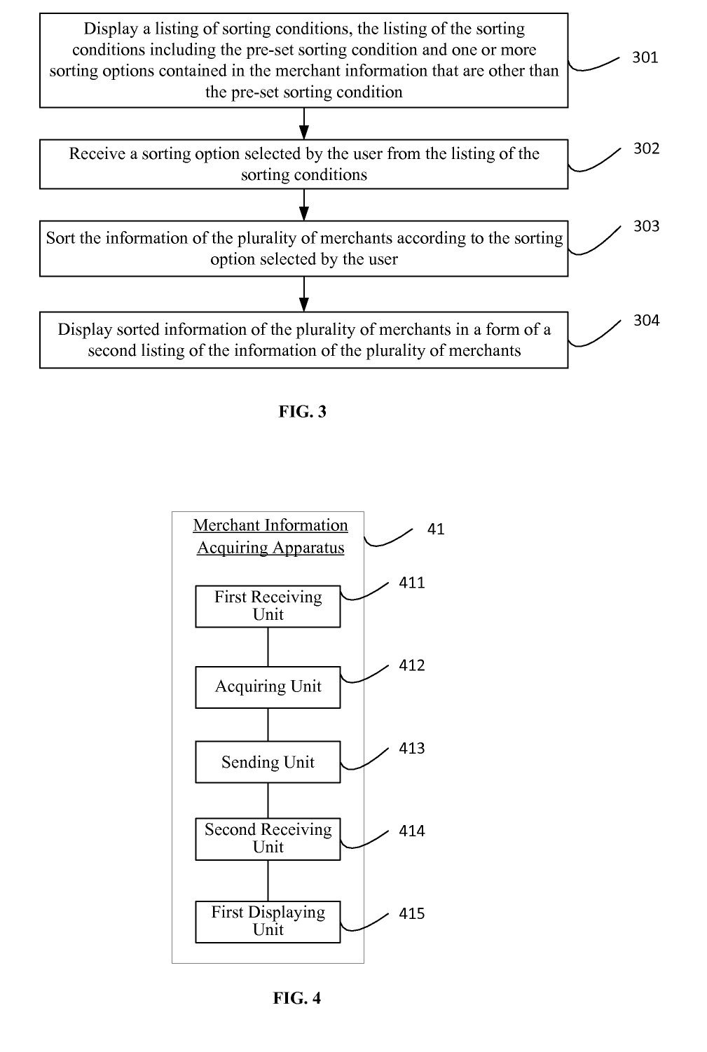

Further, as depicted in FIG. 3, after Step 202 in FIG. 2 of displaying the sorted result in a form o f a first listing of the information of the plurality of merchants, exemplary methods further includes the process depicted in FIG. 3.

In Step 301, a listing of sorting conditions is displayed. The listing of the sorting conditions includes the pre-set sorting condition and one or more sorting options contained in the merchant information that are other than the pre-set sorting condition.

As depicted in Table 4, a listing of sorting conditions includes a pre-set sorting condition and one or more sorting options contained in the merchant information that are other than the pre-set sorting condition.

TABLE 4
Listing of Sorting Conditions
Merchant name
Merchant address
Distance
Average spending per person
Business hour

Further, an evaluation item can be added to the listing of sorting conditions to sort the merchant information according to the evaluation (e.g., grading or ranking) of the merchant.

In Step 302, a sorting option selected by the user is received from the listing of the sorting conditions. In Step 303, the information of the plurality of merchants is sorted according to the sorting option selected by the user. In Step 304, the sorted information of the plurality of merchants is displayed in a form of a second listing of the information of the plurality of merchants. The listing of merchant information displays the information of the plurality of merchants.

In one embodiment as depicted in Table 5, the listing of merchant information only displays merchant names. Each merchant name corresponds to an account-linked address of the merchant. When the user clicks on the merchant name, the account-linked address of the merchant can be visited. The account-linked address is connected to an instant messaging software program including, e.g., a dialog window of a public account of the merchant. The user can send messages through the dialog window to acquire the latest merchant information including information of discounts, newly added items, etc.

TABLE 5
Listing of Merchant Information
Merchant A
Merchant B
Merchant C

In another embodiment as depicted in Table 6, the listing of merchant information further displays the merchant name, merchant address, the distance from the merchant address to the current location of the user, the average spending per person etc. When the user clicks on one item in the listing, the account-linked address of the webpage can be visited. The account link address is connected to the webpage containing the merchant information. For example, the user can access the latest merchant information including information of discounts, newly added items, etc.

TABLE 6
Listing of Merchant Information
Merchant A Address 1 Distanced by A meter
Average spending per person $X
Merchant B Address 2 Distanced by B meter
Average spending per person $Y
Merchant C Address 3 Distanced by C meter
Average spending per person $Z

When the information of the plurality of merchants is sorted according to the sorting condition selected by the user, more targeted sorting result is provided to the user for the user to search for the result.

The present disclosure further provides a merchant information acquiring apparatus as depicted in FIG. 4. The apparatus can be located, e.g., in a mobile terminal. The exemplary apparatus depicted in FIG. 4 can include a first receiving unit 411, an acquiring unit 412, a sending unit 413, a second receiving unit 414, and/or a first displaying unit 415.

The first receiving unit 411 is configured to receive an information acquiring instruction triggered by a user. The information acquiring instruction is configured to acquire the merchant information.

The acquiring unit 412 is configured to acquire current location information of the user according to the information acquiring instruction received by the first receiving unit 411.

The sending unit 413 is configured to send the location information acquired by the acquiring unit 412 and the merchant information to be acquired received by the first receiving unit 411 to a server connected to a network, wherein the server matches information according to the received location information and the merchant information.

The second receiving unit 414 is configured to receive a collection of the merchant information returned from the server. The collection of the merchant information includes information of a plurality of merchants.

The first displaying unit 415 is configured to display the information of the plurality of merchants received by the second receiving unit 414.

The present disclosure provides a merchant information acquiring apparatus 41. This apparatus can display different merchant types in the interface for the user to select. This apparatus can receive the specific merchant type selected by the user. When an information acquiring instruction is triggered by a user, current location information of the user will be acquired. The specific merchant type selected by the user and the location information will be sent to the server connected to a network. A collection of the merchant information returned from the server will be received, and the plurality of merchants will be displayed in the form of listing.

The current technology can only display one piece of merchant information at each time. If the user needs to search for other merchants in the surrounding area, the user needs to shake the mobile phone again to trigger the search. The present disclosure displays the collection of merchant information returned from the server in the form of listing. The present disclosure can provide the information of the plurality of merchants for the user in one displaying process. Further, the user can select a needed merchant type from the displaying interface, so as to expand the scope of the merchant information search as well as ensure the accuracy of the search.

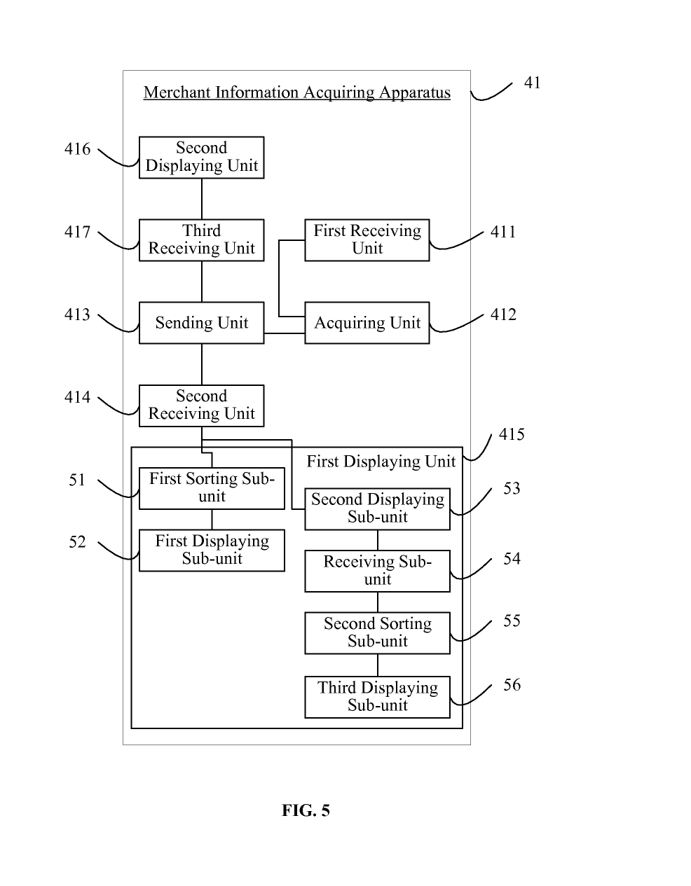

Further, the exemplary apparatus depicted in FIG. 5 can include a second displaying unit 416 and a third receiving unit 417. The second displaying unit 416 is configured to display a selection interface. The selection interface is configured for the user to select a merchant type. The third receiving unit 417 is configured to receive a selection instruction from the user. The selection instruction contains a selected merchant type selected by the user from the selection interface displayed by the second displaying unit 416.

Further, the first displaying unit 415 is further configured to display the information of the plurality of merchants received by the second receiving unit in a form of a listing of the information of the plurality of merchants.

Further, the first receiving unit 411 is further configured to receive a shaking acquiring instruction triggered by the user, wherein the shaking acquiring instruction is an instruction triggered by a shaking operation. Still further, the first receiving unit 411 is configured to receive a voice acquiring instruction triggered by the user, wherein the voice acquiring instruction is an instruction triggered by a pre-set audio.

The merchant information acquiring apparatus 41 provided by the present disclosure can trigger information acquiring instruction when the user shakes the mobile phone or blows into the microphone of the mobile phone. The user experience can be enhanced greatly when the initiation of information acquiring instruction are triggered after using the body movement (e.g., shaking and blowing) of the user.

Further, the second displaying unit 416 is further configured to display a listing of the merchant type. The listing of the merchant type contains at least two selection levels.

The merchant information acquiring apparatus 41 provided by the present disclosure can provide the user with more accurate options for the user to select, by displaying a listing o f the merchant type with at least two selection levels. In this manner, the user can be more accurately to find a merchant with improved accuracy of searching.

Further, the first displaying unit 415 includes a first sorting sub-unit 51 and a first displaying sub-unit 52. The first sorting sub-unit 51 is configured to sort the merchant information from the information of the plurality of merchants according to a pre-set sorting condition. The first displaying sub-unit 52 is configured to display the information of the plurality of merchants after sorting in a form of a first listing of the information of the plurality of merchants.

Further, the first displaying unit 415 further includes a second displaying sub-unit 53, a receiving sub-unit 54, and a second sorting sub-unit 55.

The second displaying sub-unit 53 is configured to display a listing of sorting conditions. The listing of the sorting conditions includes the pre-set sorting condition and one or more sorting options contained in the merchant information that are other than the pre-set sorting condition.

The receiving sub-unit 54 is configured to receive a sorting option selected by the user from the listing of the sorting conditions displayed by the second displaying sub-unit 53. The second sorting sub-unit 55 is configured to sort the information of the plurality of merchants according to the sorting option selected by the user and received by the receiving sub-unit 54.

The third displaying sub-unit 56 is configured to display the information of the plurality of merchants after sorting in a form of a second listing of the information of the plurality of merchants after sorting by the second sorting sub-unit 55.

When the information of the plurality of merchants is sorted according to the sorting condition selected by the user, more targeted sorting result is provided to the user, and it is easier for the user to search the result.

Ina specific embodiment, a user may purchase by a shaking operation. For example, the user can select an item (either merchandises or a merchant type) as needed from a listing provided by, e.g., an application WeChat from Tencent. After shaking a mobile phone having the WeChat installed thereon, information of the item that is physically located closest to the user can be sent to the user. In an exemplary scenario, a user may come to a shopping center, which the user is not familiar with, and may want to buy something or to have a meal. In some cases, the user may search the name of the merchandise from public reviews or searching information from Internet. With WeChat installed in the mobile phone, the user can select what he/she wants in a listing provided by WeChat, and then shake the mobile phone to find the best items or the most wanted items for purchasing. The user can be directed to the merchant address for purchasing directly. Or the user can be linked to a Grouping Purchasing page of the merchant to order online first, and then go to the merchant address for purchasing. In another specific embodiment, instead of shaking the mobile phone, the user may blow into the microphone of the mobile phone for purchasing.

In various embodiments, a merchant address database can be included. Verified merchants can themselves input location information of their shops and the keywords used to search for their shops. The address information can be used to match the location of the user quickly. The keywords searching can be used to match the keywords searched by the user quickly. In various embodiments, a searching method based on bid-ranking on the mobile terminal can be included. This maybe a method similar to the advertisement bid-ranking method from Baidu.

Note that the present disclosure can be applied not only for shopping, but also for acquiring information that is closest to the user quickly by shaking or blowing according to the location of the user. Merchandises that can be accepted include, e.g., group purchasing and bid-n-bid, etc.

Conventionally, shaking and/or blowing operations of a smart phone having WeChat can be used to find people who are shaking the mobile phone at the same time. The obtained results include the distance between the user and people found by the shaking. The searching function from bid-n-bid, or YiXun, or group purchasing can find merchants that have inputted the physical location of their shops from the backend of a corresponding website. However, the LVS location information of the user acquired by WeChat shaking may have significant deviation. This may cause the user to receive unwanted information. An internal company platform or a WeChat interface needs to be provided to clients to enter their real location information. This can avoid the problem that multiple varied location information may be entered by varied departments within the same company. This can also allow various merchants to enter or modify their information by themselves. The responding time of the searching by the user should be fast at an early stage. However, when a large number of merchants entered the platform at a later stage, there are massive matching data in the backend. The responding time to the user may be slower and may require the user to be more patient. It is desirable to shorten the responding time.

Currently, e-commerce platforms and/or online-shopping platforms can acquire merchandise information through public reviews or certain websites. The present disclosure can help ordinary merchants to increase their visibility to the large number of users who use WeChat and MicroBlog, because shopping by shaking and/or by blowing can help users to find needed information in the nearby area quickly and conveniently.

For example, a user may select “Shopping by Shaking” at WeChat and then select a searching keyword from a listing provided by WeChat. By shaking the mobile phone, the location information o f the user and the searching keyword can be sent to the server in the backend. After receiving the acquiring instruction, the backend server can process the location information of the user first, and then finds information that matching the searching keywords surrounding the location o f the user from the merchant address database stored on the server. The information may then be returned to the mobile phone of the user from the server.

As disclosed herein, a “Listing” is not limited to listings for merchandises or listings for dinning, any suitable information can be included in the listing. For example, when a user enters WeChat and selects “Shopping by Shaking”, a primary listing including options for merchandises or for dinning can be provided. When the user selects dining, the secondary listing can provide, e.g., Chinese cuisine and western cuisine. After selected from the secondary listing, a tertiary listing including, e.g., hot pot, barbeque, and/or other options can be provided for the user to select. After these exemplary selections from each selection level, the user only needs to shake the mobile phone and wanted information can be obtained.

In various embodiments, a background merchant address database of merchants or businessmen can be established. In one example, the merchant location information can be entered directly from WeChat interface. In another example, WeChat provides a platform for merchants to build a secondary domain sites to provide a login site for merchants to enter their location information and service information. The function of this site includes verification of the qualification of the merchant.

In some cases, before or during this function is in operation, the operators need to contact merchants to join the platform. After this platform has been built up with good reputation, merchants can join the platform by themselves. The qualification of the merchants must be ensured. When a large number of verified merchants enter their location information by themselves, the searching rank can be based on merchant evaluation standards and abilities. The searching rank is used to decide the frequency of the appearance of this merchant in the information returned to the user. Merchant evaluation standards include, but are not limited to, funding size, user reputation, payment made by the merchant for the bid ranking, the capacity of the merchant etc.

It should be noted that, in the present disclosure each embodiment is progressively described, i.e., each embodiment is described and focused on difference between embodiments. Similar and/or the same portions between various embodiments can be referred to with each other. In addition, exemplary apparatus (e.g., a terminal) is described with respect to corresponding methods.

The disclosed methods and/or apparatus can be implemented in a suitable computing environment. The disclosure can be described with reference to symbol(s) and step(s) performed by one or more computers, unless otherwise specified. Therefore, steps and/or implementations described herein can be described for one or more times and executed by computer(s). As used herein, the term “executed by computer(s)” includes an execution of a computer processing unit on electronic signals of data in a structured type. Such execution can convert data or maintain the data in a position in a memory system (or storage device) of the computer, which can be reconfigured to alter the execution of the computer as appreciated by those skilled in the art. The data structure maintained by the data includes a physical location in the memory, which has specific properties defined by the data format. However, the embodiments described herein are not limited. The steps and implementations described herein may be performed by hardware.

A person of ordinary skill in the art can understand that the modules included herein are described according to their functional logic, but are not limited to the above descriptions as long as the modules can implement corresponding functions. Further, the specific name of each functional module is used for distinguishing from on another without limiting the protection scope of the present disclosure.

As used herein, the term “module” can be software objects executed on a computing system. A variety of components described herein including elements, modules, units, engines, and services can be executed in the computing system. The apparatus and/or methods can be implemented in a software manner. Of course, the apparatus and/or methods can be implemented using hardware. All of which are within the scope of the present disclosure.

In various embodiments, the disclosed modules can be configured in one apparatus (e.g., a processing unit) or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

Note that, the term “comprising”, “including” or any other variants thereof are intended to cover a non-exclusive inclusion, such that the process, method, article, or apparatus containing a number of elements also include not only those elements, but also other elements that are not expressly listed; or further include inherent elements of the process, method, article or apparatus. Without further restrictions, the statement “includes . . . ” does not exclude other elements included in the process, method, article, or apparatus having those elements.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

In the disclosed methods and apparatus of acquiring merchant information, when an information acquiring instruction triggered by a user is received, current location information of the user can be acquired. Specific merchant type selected by the user and the location information of the user can be sent to a server connected to a network. A collection of the merchant information returned from the server can be received, and information of the plurality of merchants can be displayed.

While, conventionally, information of only one merchant maybe displayed and the user has to shake the mobile phone for another time to trigger the search for other merchants surrounding the area, the disclosed method can provide information of the plurality of merchants for the user in one single displaying process. Additionally, different merchant types are displayed on the selection (or displaying) interface for the user to select. The user can select a desired merchant type from the selection interface to further expand the scope for searching the merchant information and to ensure the accuracy of the search.

Further, using a listing to display merchant information can provide users with more intuitive merchant information. Further, information acquiring instruction can be triggered when the user shakes the mobile phone or blows into the microphone of the mobile phone. The user experience can be enhanced greatly when the initiation of information acquiring instruction are triggered after using the body movement (e.g., shaking and blowing) of the user. Even further, the user can be provided with more accurate options for the user to select, by displaying a listing of the merchant type with at least two selection levels.

In this manner, the user can find a merchant more accurately with improved accuracy of searching. The information of the plurality of merchants is sorted according to the pre-set sorting method. This provides convenience for the user to compare and to improve the efficiency of searching. When the information of the plurality of merchants is sorted according to the sorting condition selected by the user, more targeted sorting result is provided to the user for the user to search for the result.

What is claimed is:

1. A method of acquiring merchant information, comprising:
receiving an information acquiring instruction triggered by a user, the information acquiring instruction is configured to acquire merchant information;
acquiring current location information of the user, according to the information acquiring instruction;
sending the location information and the merchant information to be acquired to a server connected to a network, wherein the server matches information according to the received location information and the merchant information;
receiving a collection of the merchant information returned from the server, wherein the collection of the merchant information includes information of a plurality of merchants; and
displaying the information of the plurality of merchants.

2. The method according to claim 1, wherein, before the receiving of the information acquiring instruction triggered by the user, the method further includes:
displaying a selection interface, wherein the selection interface is configured for the user to select a merchant type; and
receiving a selection instruction from the user, wherein the selection instruction contains a selected merchant type selected by the user from the selection interface.

3. The method according to claim 1, wherein the displaying of the information of the plurality of merchants includes:
displaying the information of the plurality of merchants in a form o f a listing of the information of the plurality of merchants.

4. The method according to claim 1, wherein the receiving of the information acquiring instruction triggered by the user includes:
receiving a shaking acquiring instruction triggered by the user, wherein the shaking acquiring instruction is an instruction triggered by a shaking operation.

5. The method according to claim 1, wherein the receiving of the information acquiring instruction triggered by the user includes:
receiving a voice acquiring instruction triggered by the user, wherein the voice acquiring instruction is an instruction triggered by a pre-set audio.

6. The method according to claim 2, wherein the displaying of the selection interface includes:
displaying a listing of the merchant type, wherein the listing of the merchant type contains at least two selection levels.

7. The method according to claim 1, wherein the displaying of the information of the plurality of merchants in the form of listing includes:
sorting the information of the plurality of merchants according to a pre-set sorting condition to provide a sorted result; and
displaying the sorted result in a form of a first listing of the information of the plurality of merchants.

8. The method according to claim 7, wherein, after the displaying of the sorted result in the form of listing, the method further includes:
displaying a listing of sorting conditions, wherein the listing of the sorting conditions includes the pre-set sorting condition and one or more sorting options contained in the merchant information that are other than the pre-set sorting condition;
receiving a sorting option selected by the user from the listing of the sorting conditions;
sorting the information of the plurality of merchants according to the sorting option selected by the user; and
displaying sorted information of the plurality of merchants in a form of a second listing of the information of the plurality of merchants.

9. A merchant information acquiring apparatus, comprising:
a first receiving unit, configured to receive an information acquiring instruction triggered by a user, the information acquiring instruction is configured to acquire the merchant information;
an acquiring unit, configured to acquire current location information of the user according to the information acquiring instruction received by the first receiving unit;
a sending unit, configured to send the location information acquired by the acquiring unit and the merchant information to be acquired received by the first receiving unit to a server connected to a network, wherein the server matches information according to the received location information and the merchant information;
a second receiving unit, configured to receive a collection of the merchant information returned from the server, wherein the collection of the merchant information includes information of a plurality of merchants; and
a first displaying unit, configured to display the information of the plurality of merchants received by the second receiving unit.

10. The apparatus according to claim 9, wherein the apparatus further includes:
a second displaying unit, configured to display a selection interface, wherein the selection interface is configured for the user to select a merchant type; and
a third receiving unit, configured to receive a selection instruction from the user, wherein the selection instruction contains a selected merchant type selected by the user from the selection interface displayed by the second displaying unit.

11. The apparatus according to claim 9, wherein the first displaying unit is further configured to display the information of the plurality of merchants received by the second receiving unit in a form of a listing of the information of the plurality of merchants.

12. The apparatus according to claim 9, wherein the first receiving unit is further configured to receive a shaking acquiring instruction triggered by the user, wherein the shaking acquiring instruction is an instruction triggered by a shaking operation.

13. The apparatus according to claim 9, wherein the first receiving unit is further configured to receive a voice acquiring instruction triggered by the user, wherein the voice acquiring instruction is an instruction triggered by a pre-set audio.

14. The apparatus according to claim 10, wherein the second displaying unit is further configured to display a listing of the merchant type, the listing of the merchant type contains at least two selection levels.

15. The apparatus according to claim 11, wherein the first displaying unit includes:
a first sorting sub-unit, configured to sort the merchant information from the information of the plurality of merchants according to a pre-set sorting condition; and
a first displaying sub-unit, configured to display the information of the plurality of merchants after sorting in a form of a first listing of the information of the plurality of merchants.

16. The apparatus according to claim 15, wherein the first displaying unit further includes:
a second displaying sub-unit, configured to display a listing of sorting conditions, wherein the listing of the sorting conditions includes the pre-set sorting condition and one or more sorting options contained in the merchant information that are other than the pre-set sorting condition;
a receiving sub-unit, configured to receive a sorting option selected by the user from the listing of the sorting conditions displayed by the second displaying sub-unit;
a second sorting sub-unit, configured to sort the information of the plurality of merchants according to the sorting option selected by the user and received by the receiving sub-unit; and
a third displaying sub-unit, configured to display the information of the plurality of merchants after sorting in a form of a second listing of the information of the plurality of merchants after sorting by the second sorting sub-unit.
